(19) United States
(12) Patent Application Publication
(10) Pub. No.: US 2007/0266161 A1
(43) Pub. Date: Nov. 15, 2007

(54) METHODS AND SYSTEM FOR FAST SESSION ESTABLISHMENT BETWEEN EQUIPMENT USING H.324 AND RELATED TELECOMMUNICATIONS PROTOCOLS

(75) Inventors: Brody Kenrick, San Francisco, CA (US); Marwan A. Jabri, Tiburon, CA (US); Robert Jongbloed, Rozelle (AU); David Jack, Reading (GB); Albert Wong, Rohnert Park, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Dilithium Networks Pty Ltd., Broadway (AU)

(21) Appl. No.: 11/548,670

(22) Filed: Oct. 11, 2006

Related U.S. Application Data
(63) Continuation-in-part of application No. 10/732,917, filed on Dec. 9, 2003, now Pat. No. 7,139,279.
(60) Provisional application No. 60/725,950, filed on Oct. 11, 2005.
(60) Provisional application No. 60/433,252, filed on Dec. 12, 2002.

(51) Int. Cl. G06F 15/16

(52) U.S. Cl. 709/227

(57) ABSTRACT

A method of reducing a call set-up time between a pair of H.324-like terminals coupled to one or more telecommunication networks includes providing a first capability identifier in at least one of a non-standard or generic field of a first TCS message, transmitting the first capability identifier from the first H.324-like terminal to the second H.324-like terminal, and receiving, at the first H.324-like terminal, a second capability identifier in at least one of a non-standard or generic field of a second TCS message transmitted from the second H.324-like terminal. The method also includes determining, at the first H.324-like terminal, a mode of operation by utilizing an inference algorithm based upon at least the first capability identifier and the second capability identifier. The method further includes transmitting media from the first H.324-like terminal to the second H.324-like terminal in accordance with the determined mode of operation.

### CROSS-REFERENCES TO RELATED APPLICATIONS

This application claims priority to U.S. Provisional No. 60/725,950, filed Oct. 11, 2005, the specification of which is incorporated by reference herein in its entirety. This application is a continuation-in-part of U.S. patent application Ser. No. 10/732,917, filed Dec. 9, 2003, which claims priority to U.S. Provisional Patent Application No. 60/433,252, filed Dec. 12, 2002, the specifications of which are incorporated by reference herein in their entirety.

### COPYRIGHT NOTICE

A portion of this application contains computer codes, which are owned by Dilithium Networks Pty Ltd. All rights have been preserved under the copyright protection, Dilithium Networks Pty Ltd. ©2006.

### BACKGROUND OF THE INVENTION

The present invention relates generally to methods of establishing multimedia telecommunication (a multimedia “call”) between equipment (“terminals”). More particularly, the invention provides methods for reducing the time required to establish calls between terminals that implement the ITU-T H.324 Recommendation and other Standards and Recommendations derived from or related to this such as the 3G-324M recommendation developed and adopted by the Third Generation Partnership Projects (3GPP and 3GPP2). Merely by way of example, the invention has been applied to performing a fast session setup procedure over the H.245 control-channel utilizing an inference algorithm, but it would be recognized that the invention may also include other applications.

H.324 is an International Telecommunication Union (ITU) protocol standard for multimedia communication over general switched networks (GSTN). H.324M is an extension of H.324 for operations over mobile networks, and 3G-324M is a recommendation by the third generation partnership program (3GPP) defining adaptation of H.324M for use within 3GPP and also adopted by 3GPP2. Equipment and devices and systems employing protocols based on or derived from H.324 are referred to herein as H.324-like equipment. H.324-like equipment can connect to other H.324-like equipment via switching centers and to other non-H.324-like equipment through multimedia gateways. An example of a non-H.324-like equipment is H.323 equipment. H.323 is an International Telecommunication Union protocol Standard for multimedia communication over non-guaranteed bandwidth packet networks. H.323-like equipment is equipment that employs a protocol based or derived from the H.323 protocol.

Without any loss of generality, we will use the term “H.324” to indicate H.324-like equipment including H.324M and 3G-324M equipment and “H.323” to indicate H.323-like equipment. Also without any loss of generality we use the term “equipment” to indicate either user end equipment such as a handset, or network end equipment such as a switch or gateway. We also use the terms “equipment” and “terminal” interchangeably, and they both indicate the same meaning in the present document.

FIG. 1 is a diagram illustrating communication flow between two H.324 terminals when an H.245 Request message is sent from one terminal to the other. We will refer to the sequence of H.245 Request and Response messages shown in FIG. 1 as a “round trip” and the time associated with completing it as a “round trip delay.” As illustrated in FIG. 1, the steps involved in setting up and connecting a typical H.324 call are as follows:

1. Call signaling (bearer establishment, not shown)

2. Mobile level detection (MLD)

3. Terminal Capability Exchange (TCS)

4. Master Slave determination (MSD)

5. Open/Close Logical Channels (OLC)

6. Multiplexer Table Entries Exchange (MTE)

Steps (3) to (6) are performed using a sequence of H.245 Request and Response messages as described above and illustrated in FIG. 1. Note the order of steps (5) and (6) above can be interchanged. It should be noted that Steps (3) to (6) relate to procedures that are defined by underlying state machines that are also known as Signaling Entities. The relevant signaling entities are:

1. Capability Exchange Signaling Entity (CESE)

2. Master Slave Determination Signaling Entity (MSDSE)

3. Logical Channel Signaling Entity (LCSE)

4. Multiplex Table Signaling Entity (MTSE)

Once these steps have completed, media (video, audio and data) can flow between the terminals in logical channels. Note the H.245 messages flow on the Logical Channel 0, which is predefined, and are carried by the means of the multiplexer predefined Multiplex Table Entry 0. Once other Multiplex Table Entries have been exchanged, these can also be used in conjunction with H.245 messages.

Utilizing the communication flow illustrated in FIG. 1 results in as many as ten H.245 message round trip delays in order to establish an H.324 session with two logical channels in each direction.

Arising from the set of procedures described above that are used to establish an H.324M call, when a call is made from an H.324M terminal, it is prone to suffer from long call setup time, which is the interval between the time that the call signaling is initiated to the time that the exchange of voice and video commences between an H324-like end-point (H.324, H.324M or 3G-324M) and other terminals whether H.324-like or not. Thus there exists a need for techniques to speed up the call set-up between H.324 like terminals and other terminals either of the H.324 type directly, or terminals such as H.323, SIP, or RTSP via multimedia gateways.

### SUMMARY OF THE INVENTION

According to the present invention, techniques for telecommunications are provided. More particularly, the invention provides methods for reducing the time required to establish calls between terminals that implement the ITU-T H.324 Recommendation and other Standards and Recommendations derived from or related to this such as the 3G-324M recommendation developed and adopted by the Third Generation Partnership Projects (3GPP and 3GPP2).

According to an embodiment of the present invention, a method of reducing a call set-up time between a pair of H.324-like terminals coupled to one or more telecommunication networks is provided. The method includes providing a first capability identifier in at least one of a non-standard or generic field of a first TCS message, transmitting the first capability identifier from the first terminal to the second terminal, and receiving, at the first terminal, a second capability identifier in at least one of a non-standard or generic field of a second TCS message. The second TCS message is transmitted from the second terminal. The method also includes determining, at the first terminal, a mode of operation by utilizing an inference algorithm. Determining is based upon at least the first capability identifier and the second capability identifier. The method further includes transmitting media from the first terminal to the second terminal. Transmitting media is performed in accordance with the determined mode of operation.

According to another embodiment of the present invention, a method of reducing a call set-up time for a call between a first terminal and a second terminal is provided. The call uses one or more telecommunication networks. The method includes providing a first capability identifier in a GenericCapabilities field of a first TCS message, transmitting the first TCS message from the second terminal to the first terminal, and receiving a first media stream at the second terminal prior to receiving a second TCS message from the first terminal. The second TCS message includes a second capability identifier in a GenericCapabilities field of the second TCS message. The method also includes thereafter receiving the second TCS message at the second terminal, determining a mode of operation for the call based upon the first capability identifier and the second capability identifier, and performing a media recovery operation. The method further includes receiving a second media stream at the second terminal and decoding the second media stream. Decoding the second media stream is performed in accordance with the determined mode of operation.

According to an alternative embodiment of the present invention, a method of performing a reduced time call set-up process between two H.324-like devices coupled to a telecommunications network is provided. The method includes determining a multiplexer level and transmitting at least a first TCS message from a first H.324-like device to a second H.324-like device. The at least a first TCS message includes a first capability indication in a GenericCapability field of the at least a first TCS message. The method also includes receiving, at the first H.324-like device, at least a second TCS message transmitted from the second H.324-like device. The at least a second TCS message includes a second capability indication in a GenericCapability field of the at least a second TCS message. The method further includes determining one or more media channel properties utilizing an inference algorithm. Determining is based on the first capability indication and the second capability indication. Additionally, the method includes transmitting a TCS acknowledgement message from the first H.32-like device to the second H.324-like device and transmitting media from the first H.324-like device to the second H.324-like device utilizing the one or more media channel properties.

According to another alternative embodiment of the present invention, a method of performing call set-up between a pair of terminals coupled to a telecommunications network is provided. The method includes transmitting a first TCS message from a first terminal to a second terminal. The first TCS message includes a first capability indication in at least one of a non-standard or generic field of the first TCS message. The method also includes retransmitting the first TCS message a predetermined number of times prior to receiving a second TCS message transmitted from the second terminal to the first terminal. The second TCS message includes a second capability indication in at least one of a non-standard or generic field of the second TCS message. The method further includes thereafter receiving the second TCS message transmitted from the second terminal to the first terminal and thereafter transmitting a media stream from the first terminal to the second terminal.

According to a particular embodiment of the present invention, a computer-readable medium including computer executable instructions for reducing a call set-up time between a pair of H.324-like terminals coupled to one or more telecommunication networks is provided. The computer-readable medium includes one or more instructions for providing a first capability identifier in at least one of a non-standard or generic field of a first TCS message, one or more instructions for transmitting the first capability identifier from the first H.324-like terminal to the second H.324-like terminal, and one or more instructions for receiving, at the first H.324-like terminal, a second capability identifier in at least one of a non-standard or generic field of a second TCS message. The second TCS message is transmitted from the second H.324-like terminal. The computer-readable medium also includes one or more instructions for determining, at the first H.324-like terminal, a mode of operation by utilizing an inference algorithm. D determining is based upon at least the first capability identifier and the second capability identifier. The computer-readable medium further includes one or more instructions for transmitting media from the first H.324-like terminal to the second H.324-like terminal. Transmitting media is performed in accordance with the determined mode of operation.

According to another particular embodiment, a computer-readable medium including computer executable instructions for reducing a call set-up time for a call between a first terminal and a second terminal is provided. The call uses one or more telecommunication networks. The computer-readable medium includes one or more instructions for providing a first capability identifier in a GenericCapabilities field of a first TCS message, one or more instructions for transmitting the first TCS message from the second terminal to the first terminal, and one or more instructions for receiving a first media stream at the second terminal prior to receiving a second TCS message from the first terminal. The second TCS message includes a second capability identifier in a GenericCapabilities field of the second TCS message. The computer-readable medium also includes one or more instructions for thereafter receiving the second TCS message at the second terminal, one or more instructions for determining a mode of operation for the call based upon the first capability identifier and the second capability identifier, and one or more instructions for performing a media recovery operation. The computer-readable medium further includes one or more instructions for receiving a second media stream at the second terminal and one or more instructions for decoding the second media stream. Decoding the second media stream is performed in accordance with the determined mode of operation.

According to yet another particular embodiment of the present invention, a computer-readable medium including computer executable instructions for performing a reduced time call set-up process between two H.324-like devices coupled to a telecommunications network is provided. The computer-readable medium includes one or more instructions for determining a multiplexer level and one or more instructions for transmitting at least a first TCS message from a first H.324-like device to a second H.324-like device. The at least a first TCS message includes a first capability indication in a GenericCapability field of the at least a first TCS message. The computer-readable medium also includes one or more instructions for receiving, at the first H.324-like device, at least a second TCS message transmitted from the second H.324-like device. The at least a second TCS message includes a second capability indication in a GenericCapability field of the at least a second TCS message. The computer-readable medium further includes one or more instructions for determining one or more media channel properties utilizing an inference algorithm. Determining is based on the first capability indication and the second capability indication. Moreover, the computer-readable medium includes one or more instructions for transmitting a TCS acknowledgement message from the first H.32-like device to the second H.324-like device and one or more instructions for transmitting media from the first H.324-like device to the second H.324-like device utilizing the one or more media channel properties.

According to an alternative embodiment of the present invention, a method of initiating a call between users with reduced call set-up times using one or more telecommunication networks is provided. The method is provided between at least a pair of H.324-like terminals coupled to the one or more telecommunication networks. The method includes transmitting a call signaling message from a first terminal to a second terminal through a telecommunication network to initiate a call, receiving a call signaling message from the second terminal to the first terminal through the telecommunication network, and providing one or more custom Non-Standard H.245 messages or custom Non-Standard fields, or generic extension fields in standard messages. The one or more custom H.245 messages or custom Non-Standard fields or generic extension fields are associated with one or more set up parameters for an initial predetermined mode of operation. The method also includes transmitting the one or more custom Non-Standard H.245 messages or custom Non-Standard fields or generic extension fields in standard messages from the first terminal to the second terminal, transmitting a custom Non-Standard response message associated with the one or more custom Non-Standard H.245 messages or custom Non-Standard fields or generic extension fields from the second terminal to the first terminal, and establishing the initial predetermined mode of operation between the first terminal and the second terminal through the bearer channel based upon at least one or more of the custom H.245 messages or custom Non-Standard fields or generic extension fields.

The one or more custom Non-Standard H.245 messages may be represented themselves as one or more Non-Standard Capabilities embedded in a H.245 terminal capability set request message. Alternatively, the one or more custom Non-Standard H.245 messages may be represented as one or more GenericInformation capabilities embedded in a H.245 terminal capability set request message. One or more user preferences, either coded or explicit, are provided in one of the custom Non-Standard H.245 messages in a specific embodiment. Additionally, a capability of at least one of the first terminal or the second terminal may be included in a TerminalCapabilitySet field.

In another alternative embodiment, the method additionally includes providing a concatenated message by concatenating a MasterSlaveDetermination request message with the TerminalCapabilitySet field and transmitting the concatenated message from the first terminal to the second terminal. In this alternative embodiment, the one or more custom Non-Standard response messages may be provided as one or more media streams.

According to yet another alternative embodiment of the present invention, a method of initiating a call between users with reduced call set-up times using one or more telecommunication networks is provided. The method is provided between at least a pair of H.324-like terminals coupled to the one or more telecommunication networks. The method includes transmitting a call signaling message from a first terminal to a second terminal through a telecommunication network to initiate a call, receiving a call signaling message from the second terminal to the first terminal through the telecommunication network, and providing one or more custom Non-Standard H.245 messages or custom Non-Standard fields in standard messages. The one or more custom H.245 messages or custom Non-Standard fields are associated with one or more set up parameters for an initial predetermined mode of operation. The method also includes transmitting the one or more custom Non-Standard H.245 messages or custom Non-Standard fields in standard messages from the first terminal to the second terminal, transmitting a custom Non-Standard response message associated with the one or more custom Non-Standard H.245 messages or custom Non-Standard fields from the second terminal to the first terminal, transmitting media from the first terminal to the second terminal, retransmitting the one or more custom Non-Standard H.245 messages or custom Non-Standard fields in standard messages from the first terminal to the second terminal, receiving a media recovery signal from the second terminal, and establishing the initial predetermined mode of operation between the first terminal and the second terminal through the bearer channel based upon at least one or more of the custom H.245 messages or custom Non-Standard fields.

The capability of at least one of the first terminal or the second terminal may be included in a TerminalCapabilitySet field. Additionally, the media recovery signal may be a VideoFastUpdatePicture signal. In an embodiment, the media recovery signal is a CloseLogicalChannel signal. In another embodiment, the media recovery signal is a custom signal. In an alternative embodiment, the method further includes providing a concatenated message by concatenating a MasterSlaveDetermination request message with the TerminalCapabilitySet field and transmitting the concatenated message from the first terminal to the second terminal.

These methods may be used separately or severally to reduce the time that is taken from the point when a user requests the establishment of a call to the point where media can be played at the terminals. Merely by way of example, the invention has been applied to the establishment of multimedia telecommunication between 3G-324M (H.324M based protocol) multimedia handsets on a mobile telecommunications network, and between 3G-324M multimedia handsets and H.323 based terminals on a packet network using a Multimedia Gateway to mediate between the protocols used at each endpoint, but it would be recognized that the invention may also include other applications.

Numerous benefits are achieved using the present invention over conventional techniques. For example, in an embodiment according to the present invention, telecommunications techniques are provided that provide session setup times faster than other control channel based proposals. Additionally, embodiments provide non-variable (exclusive of variability in mobile level setup) performance in good network conditions and handle error conditions with reduced to minimal impact on performance. Moreover, other embodiments provide a significantly less complicated implementation than other control channel based proposals and utilize little to no buffering. Depending upon the embodiment, one or more of these benefits may exist. These and other benefits have been described throughout the present specification and more particularly below. Various additional objects, features and advantages of the present invention can be more fully appreciated with reference to the detailed description and accompanying drawings that follow.

### BRIEF DESCRIPTION OF THE DRAWINGS

FIG. 1 is a diagram illustrating a conventional call set-up procedure between two H.324 terminals;

FIG. 2 is a diagram illustrating communication flow between two H.324 terminals using extensions of H.245 messages to reduce connection times for H.324 calls according to an embodiment of the present invention;

FIG. 3 is a diagram illustrating communication flow between two H.324 terminals using extensions of H.245 messages and concatenation to reduce connection times for H.324 calls according to an embodiment of the present invention;

FIG. 4 is a diagram illustrating an alternative communication flow between two H.324 terminals using extensions of H.245 messages to reduce connection times for H.324 calls according to another embodiment of the present invention;

FIG. 5A is a diagram illustrating a method of recovering media after loss of a preference message according to an embodiment of the present invention;

FIG. 5B is a diagram illustrating a method of recovering media after loss of a preference message according to an embodiment of the present invention;

FIG. 6 is a simplified flowchart illustrating a method of reducing a call set-up time for a call between H.324-like terminals according to an embodiment of the present invention;

FIG. 7 illustrates Object Identifier Assignments for an FSS procedure according to an embodiment of the present invention;

FIG. 8 illustrates an example of an ASN.1 description containing the syntax for messaging data according to an embodiment of the present invention; and

FIG. 9 illustrates an example of an ASN.1 description containing the syntax for encoded data according to an embodiment of the present invention.

### DETAILED DESCRIPTION OF SPECIFIC EMBODIMENTS

According to the present invention, techniques for telecommunications are provided. More particularly, the invention provides methods for reducing the time required to establish calls between terminals that implement the ITU-T H.324 Recommendation and other Standards and Recommendations derived from or related to this such as the 3G-324M recommendation developed and adopted by the Third Generation Partnership Projects (3GPP and 3GPP2). Merely by way of example, the invention has been applied to performing a fast session setup procedure over the H.245 control-channel utilizing an inference algorithm, but it would be recognized that the invention may also include other applications.

The methods described herein are generic and can be implemented in many different ways by a person skilled in the art. We describe herein exemplary embodiments to illustrate the methods which can be adapted easily to suit specific equipment needs.

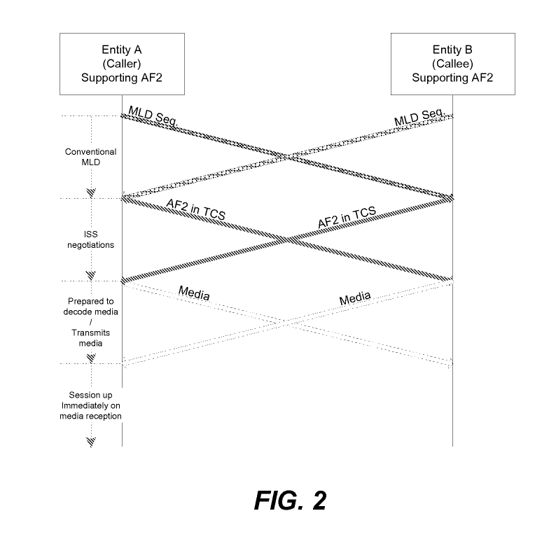

FIG. 2 is a diagram illustrating communication flow between two H.324 terminals using extensions of H.245 messages to reduce connection times for H.324 calls according to an embodiment of the present invention. As illustrated in FIG. 2, a method is provided in which call set-up times are reduced (i.e., the number of sequential steps used to establish an H.324-like call are reduced) by using the non-standard or generic messaging capabilities of the H.245 protocol during the call set-up process. In embodiments of the present invention, the use of the non-standard or generic messaging capabilities are referred to as AF2.

There are a number of ways to add non-standard messages in the H.245 protocol in order to speed up the call. One approach provided herein is the use of a non standard, or generic, capability within the H.245 TerminalCapabilitySet message and/or a NonStandardMessage H.245 Response message. According to an embodiment of the present invention, a terminal includes a capability in the GenericInformation field in the TerminalCapabilitySet. According to another embodiment, information related to a capability of a terminal is included in the GenericInformation field in the TerminalCapabilitySet message. The capability used in a particular embodiment is the FSS request message {itu-t(0) recommendation(0) h(8) 324 generic-capabilities(1) fastSessionSetup(0) explicit profile (2), with this OID in genericInformation.messageIdentifier field}. According to some embodiments, the mobileLevel field is not used.

These messages can be used to signal that the calling equipment is capable of operating in a particular way, and to provide proposals and preferences to the remote terminal relating to Master Slave Determination, Logical Channel(s) to be opened and Multiplexer Table Entries embedded within these non-standard extensions to accelerate call set-up. If the remote terminal supports this method, it may signal the calling terminal using a non-standard extension which will also indicate that it accepts, and may also propose modifications or provide other information, including for example the Multiplexer Table Entries that it is using.

If the called terminal does not support this method (i.e., the inclusion of a non-standard capability in the H.245 messaging), the terminal will simply ignore the non-standard extension and not respond with the non-standard response, but a standard response (e.g., a conventional TCSAck). The call will then proceed as for a standard H.324-like call, utilizing normal H.245 negotiation to continue the call set-up. These fallback modes are well known to one of skill in the art. The use of Non-Standard messaging does not require non-supporting terminals to handle concatenation methods as described more fully below.

As illustrated in FIG. 2, an MLD sequence is performed between the two terminals Entity A (Caller) and Entity B (Callee). As will be evident to one of skill in the art, prior to the MLD sequence, a call signaling message is transmitted from the first terminal to the second terminal through the telecommunication network. The call signaling message is used to initiate a call. A bearer channel is established between the first terminal and the second terminal once the call signaling message has been received by the second terminal. Then a common mobile level for operation is determined.

One or more custom Non-Standard H.245 messages or custom Non-Standard fields are provided in standard messages as illustrated after the conventional MLD process shown in FIG. 2. In FIG. 2, the one or more custom Non-Standard H.245 messages, custom Non-Standard fields in standard messages, or messages in generic fields are illustrated as “AF2 in TCS,” that is, messaging in the terminal capability set (TCS) field.

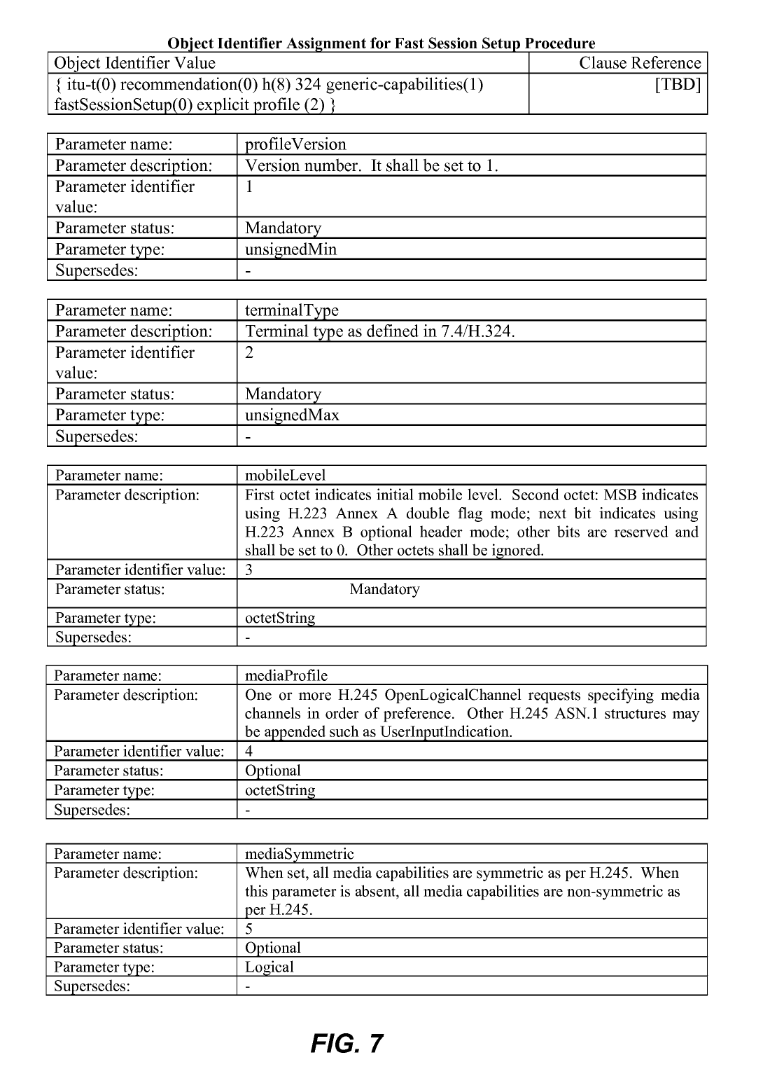

In a particular embodiment of the method of using custom H.245 messages, a non-standard Capability is used. Typically, in conventional H.324-like equipment, the first H.245 message sent is a Terminal Capability Set (TCS) message. The calling equipment includes a capability of type NonStandardParameter in the TCS it sends to the answering equipment. This capability is identified by a NonStandardIdentifier with a unique Object Identifier. This capability contains the additional parameters needed by the called terminal to start the call, including terminalType (needed for MSD in the same manner as it is required for standard H.245 operation) and Multiple Table Entry (MTE) Descriptors. FIG. 8 shows an example of an ASN.1 description containing the syntax for these data. By including this NonStandard Capability, the calling party is enabled to accept the decision of the called party as to whether this method is used, and what channels are selected.

According to embodiments of the present invention, the response message is not required to determine what channels are selected. A determination of the inferred common mode (ICM) follows the rules defined in FSS using only the information available in the first H.245 message group, the TCS and/or the MSD and any custom messages contained therein.

According to one embodiment of the inference algorithm for an inferred common mode, the codecs are selected in the same way as normal H.245 message exchange, except all transactions are conducted implicitly till the final outcome, this outcome forms the inferred common mode. The following discussion provides examples of inference algorithms and is provided merely by way of example. One of ordinary skill in the art would recognize many variations, modifications, and alternatives.

Adaptation layer settings are specified by the local terminal in OpenLogicalChannel messages. For each media, adaptation layer 3 (AL3) is commonly supported. If only AL3 is specified for a media in the mediaProfiles of a terminal, only AL3 is supported. If AL2 is included, both AL2 and AL3 are supported. If AL1 is included, all AL1, AL2 and AL3 are supported. [0048] Initial logical channel number selections are made by the local terminal. If a reverse channel number conflicts with a receive channel number opened by the remote, the receive channel number will use the next available logical channel number. The processing of channels should be from the first entry of the mediaProfiles. Conflicts that can occur during determination of ICM and logical channel number are resolved implicitly as described above.

In this inference algorithm, media are represented by a list OpenLogicalChannel. Media preferences may be indicated by specifying more than one OpenLogicalChannel, with the same logical channel number in the desired logical channel preference order. If more than one logical channel of the same type is expected to be opened, different OpenLogicalChannel message of the same media type but different logical channel numbers are specified. Further symmetric codecs are indicated by specifying a separate OpenLogicalChannel with reverse logical channel parameter only, which is the same as the expected symmetric media type.

By way of example, the following describes the inference outcome using this embodiment. Terminal capability sets for both terminals are inferred from the combination of mediaProfiles from local and remote. Multiple OpenLogicalChannel entries with the same LCN correspond to a series of alternative capability descriptor entry; OpenLogicalChannels with different LCNs correspond to simultaneous capability descriptor entries.

The capability direction is set to receive capability (e.g. receiveVideoCapability, receiveAudioCapability) unless symmetric is set, where the capability direction is set to receive and transmit capability (e.g. receiveAndTransmitVideoCapability, receiveAndTransmitAudioCapability).

The set of capability descriptors is derived with the same order of preference as the order in mediaProfile, and includes by default an instance of each logical channel type. The remote terminal is assumed to support all adaptation layers (AL1, AL2 and AL3) for all media categories (audio, video and data). Other settings in the TerminalCapabilitySet adopt the corresponding recommended values specified in 3GPP TR 26.110, H.324, H.245 and H.223.

Codecs are selected in the same way as normal H.245 message exchanges, deduced according to capability preferences and media mode conflict resolution as in B.2.2.2/H.324 and C.4.1.3/H.324. Channels are considered open following the computation of the inferred mode. The peer's channel is selected by reversing the TCS inputs to the selection algorithm.

The following behavior is described as a method to minimize the chance of endpoints attempting to open conflicting logical channels when the slave endpoint has symmetric capability limitations. When the master and the slave have indicated choices of receive capabilities for a particular media type, the slave should attempt to open a logical channel for the master's most preferred capability for which it has capability, as given by the order the master has expressed its capabilities; and the master should attempt to open a logical channel for its most preferred capability for which the slave has capability, as given by the order it has expressed its capabilities.

If a terminal has a preference for the mode it would like to transmit or receive, and wishes to express this when transmitting its capabilities, it may do so by giving CapabilityDescriptors that relate to its preferred mode or modes small values of capabilityDescriptorNumber.

An example of ICM that does NOT have symmetric codecs set is shown in Table 1.

TABLE 1

| Entity A (Master) | Entity B (Slave) |
|---|---|
| LCN1: AMR Tx, AL2 | LCN1: AMR Tx, AL2 |
| LCN2: MPEG4 Tx, AL2 | LCN1: G.723.1 Tx, AL2 |
| LCN2: H.263 Tx, AL2 | LCN2: H.263 Tx, AL2 |
| | LCN2: MPEG4 Tx, AL2 |
| LCN1, AMR Tx, AL2 | LCN1: AMR Tx, AL2 |
| LCN2: H.263 Tx, AL2 | LCN2: MPEG4 Tx, AL2 |

In this example, each entity selects media channels most preferred for reception by its peer entity. Both entities prefer AMR. Entity A prefers to receive MPEG4-Video while entity B prefers to receive H.263.

An example of ICM that does have symmetric codecs set is shown in Table 2.

TABLE 2

| Entity A (Master) | Entity B (Slave) |
|---|---|
| LCN1: AMR Tx, AL2 | LCN1: AMR Tx, AL2 |
| LCN2: MPEG4 Tx, AL2 | LCN1: G.723.1 Tx, AL2 |
| LCN2: H.263 Tx, AL2 | LCN2: H.263 Tx, AL2 |
| | LCN2: MPEG4 Tx, AL2 |
| LCN1, AMR Tx, AL2 | LCN1: AMR Tx, AL2 |
| LCN2: MPEG4 Tx, AL2 | LCN2: MPEG4 Tx, AL2 |

In this example, each entity selects media channels most preferred for reception by its peer entity. Both entities prefer AMR. Entity A prefers to receive MPEG4-Video while entity B uses MPEG4-Video in symmetry to the master.

Embodiments of the present invention utilize an inferred common mode (ICM) procedure. For example, in a particular embodiment, the ICM is the unique media mode determined by both terminals based on local profile request and peer profile request. In a particular implementation, the ICM is the same for both terminals.

In an embodiment, if a called terminal receives a TCS containing the NonStandard capability relating to this method and itself supports the method, it will perform a master slave determination by comparing the terminalType value in the received NonStandard capability with the value for the local terminal. The highest value will be selected as the master. In the event of equal terminal type values, the calling terminal will be selected as the master.

Additionally, in this embodiment, the called terminal will analyze the received capability table to determine the OpenLogicalChannel and multiplex table entries for the new connection. The called terminal will respond with a normal TCSAck if it cannot derive an acceptable channel configuration, or if it is unable to accept the multiplexEntryDescriptors provided. The remainder of the call set-up will then be via normal H.245 negotiation.

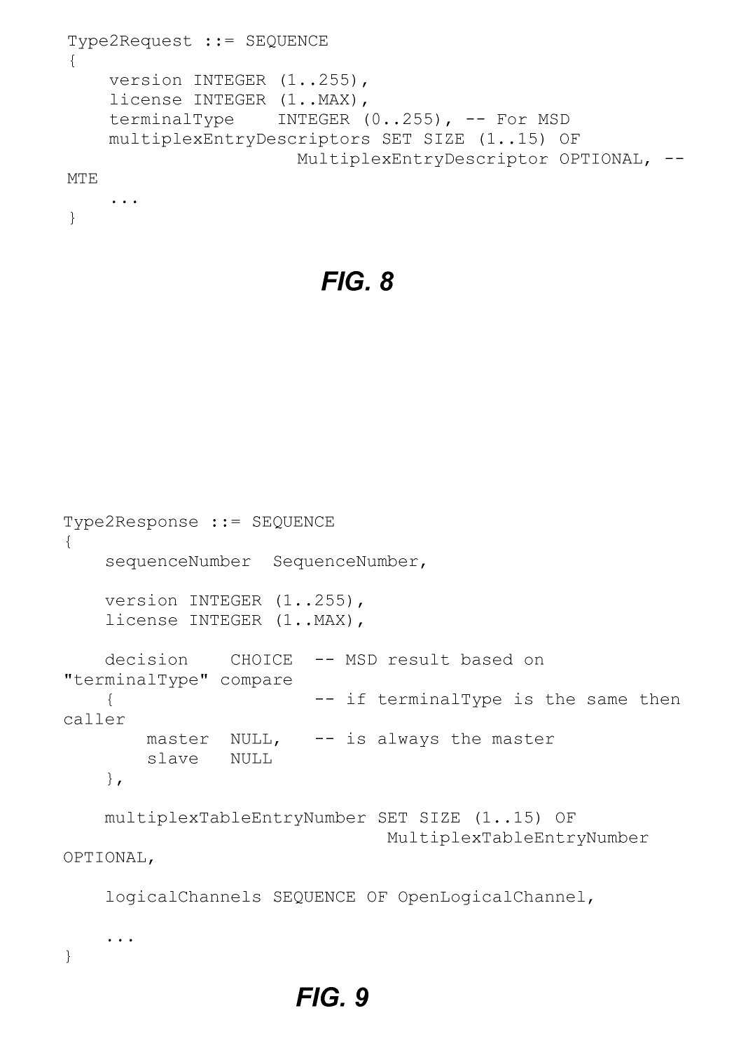

If acceptable channel configurations and multiplex table entries can be derived, the called party will replace the normal TCSAck with an H.245 ResponseMessage of the type NonStandardMessage. See FIG. 9 for an ASN.1 Syntax description of the encoded data. The NonStandardIdentifier of the non-standard response message will have the same Object Identifier as the NonStandard capability which identifies this method.

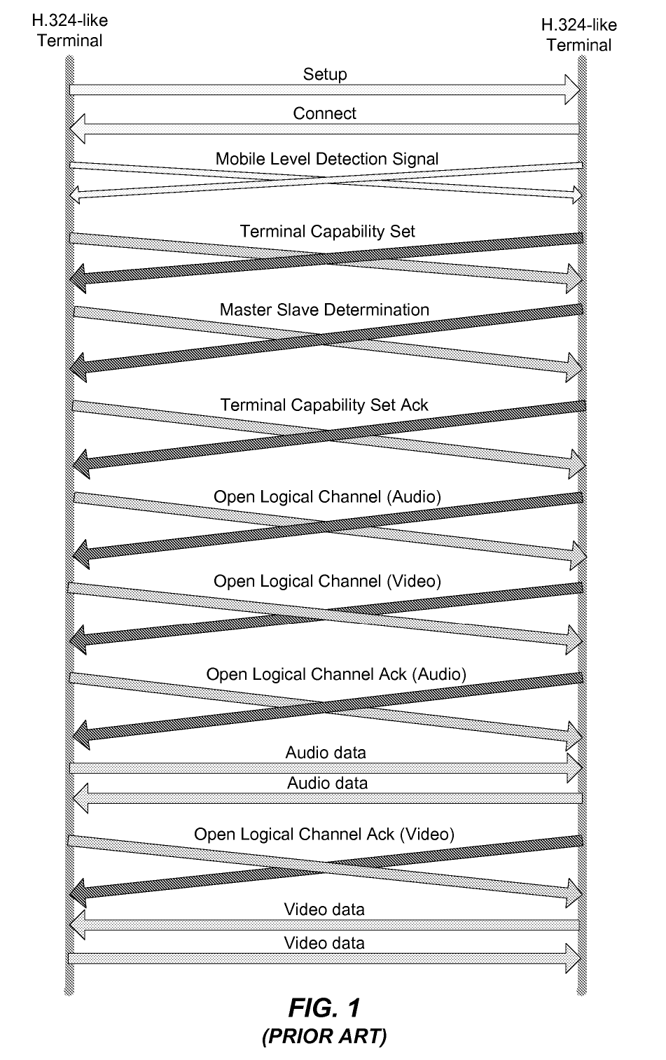

Referring to FIG. 2, media is transmitted from the first terminal to the second terminal prior to the completion of a further H.245 procedures. In particular, H.245 OpenLogicalChannel procedures do not need to be completed to establish the media stream. In contrast with FIG. 1, in which media transmission is delayed until after OpenLogicalChannel, embodiments of the present invention reduce call set-up times and thereby transmit media with less delay after bearer establishment.

Referring to FIGS. 1 and 2, there are many messages that do not need to be completed before media can be transmitted when using embodiments of this invention. These include TCSAck, MSD Ack, OLC and OLC Ack, MTE, and MTE Ack. Some or all of these messages could be employed after media transmission to modify some characteristics of the session.

The one or more custom H.245 messages or custom Non-Standard fields are associated with one or more set up parameters for a mode of operation for the call. In an embodiment, the mode of operation includes an initial mode of operation. In another embodiment, the mode of operation includes a predetermined mode of operation. The one or more custom Non-Standard H.245 messages or custom Non-Standard fields in standard messages are transmitted from the first terminal to the second terminal. In an optional process, a custom Non-Standard response message associated with the one or more custom Non-Standard H.245 messages or custom Non-Standard fields may be transmitted from the second terminal to the first terminal.

Computer-readable medium are utilized herein to provide the functionality enabled by embodiments of the present invention. Generally, the computer-readable medium include instructions utilized in practicing the methods described herein.

Embodiments of the present invention are not limited to implementations solely employing the use of Non-Standard messaging, but may include fast session set-up techniques as described throughout the present specification. As discussed below, other embodiments incorporate concatenation techniques to reduce call set-up times. In these other embodiments, other H.245 messages, such as the MasterSlaveDetermination (MSD) request message, may be concatenated with the TerminalCapabilitySet for interoperation with non-supporting terminals.

Depending on the particular embodiment, this may include ignoring the outcome of mobile level. After a terminal has received its peer's TCS, decoded it successfully, and determined an ICM, further H.245 message exchange for session setup may be skipped and opened logical channels operate immediately. A response message or confirmation message could also be sent.

Embodiments of the present invention utilizing Non-Standard messaging offer a number of benefits including one and a half less round trip exchanges than the embodiment of the method of Concatenated H.245. The expression of Capability in the NonStandard field of the TerminalCapabilitySet request message provides that the called terminal will not malfunction or hang-up as it is required to be able to handle the case of a non-standard Capability being communicated to it.

Another benefit provided herein is that the encapsulation of the custom message in the TerminalCapabilitySet request message allows the terminal to transmit the custom message in the first H.245 message after the mobile level determination is done, and hence it does not have to wait for any further messages, or acknowledgements, or underlying SRP acknowledgements, before it may transmit media. A third benefit provided herein is that the TerminalCapabilitySet request containing the Non-Standard message embedded as a non-standard Capability can be transmitted together with one or more H.245 messages using concatenation allowing for additional information to be sent for common mode inference, or for establishing sessions more quickly with terminals employing AnswerFast Type I techniques. Yet another benefit provided herein is that in embodiments in which the calling terminal presents several preferences in the Non-Standard messaging, the called terminal responds with an acknowledgement message that informs the calling terminal of the preferred modes of the called terminal and its selection of one of the preferred modes of the calling terminal.

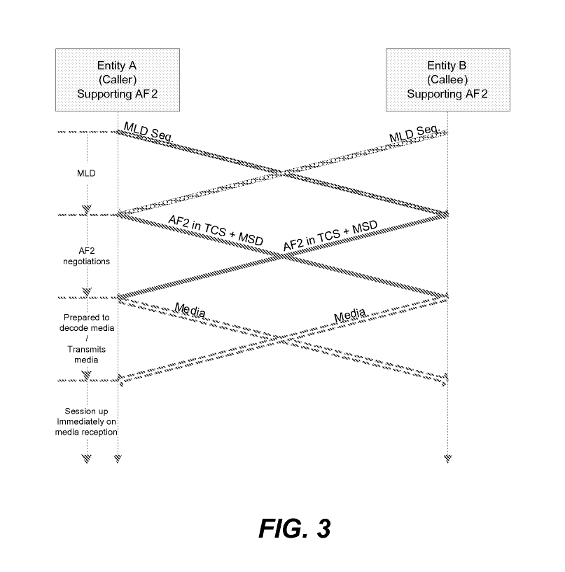

FIG. 3 is a diagram illustrating communication flow between two H.324 terminals using extensions of H.245 messages and concatenation to reduce connection times for H.324 calls according to an embodiment of the present invention. As illustrated in FIG. 3, call set-up times are reduced by concatenating multiple H.245 messages in one or more SRP/NSRP (H.245 PDU) Command Frames. Accordingly, the number of H.245, SRP/NSRP messages and associated round-trip delays are reduced. The H.245 messages are concatenated in a way as not to violate inter-procedure dependencies.

The usage of H.245 within H.324 allows equipment to concatenate multiple H.245 elements into a single PDU, thus avoiding the need to use two round trips for each request/response pair due to the need for an SRP/NSRP response to be received for each H.245 PDU before the next PDU is allowed be transmitted. Embodiments of the present invention use concatenated H.245 to send multiple H.245 messages, each originating from different Signaling Entities that have no dependencies on each other, within a single H.245 PDU.

Interoperability with equipment that do not support concatenated H.245 is achieved by noting that such equipment ignores the second and subsequent H.245 elements in a PDU, so will not send any required H.245 Response messages if the ignored message is an H.245 Request message. Therefore, the first concatenated H.245 PDU sent contains at least two Request messages, where the first message is a Request. If only the Ack for the first message is received, the sending equipment will retransmit those Requests and any other messages that have not been acknowledged, and in doing this and in sending any and all subsequent H.245 messages should revert to sending only a single H.245 message in each subsequent H.245 PDU. If responses to all H.245 messages in the first H.245 PDU are received, the sending equipment can continue to use concatenated messages. The use of this technique will reduce the number of round trip delays if concatenated messages are supported. This method does not define any protocol elements additional to those already allowed and defined by the H.245 and H.324 standards. It can be considered to be utilizing the existing protocols in a smart fashion, rather than an extension to it.

Referring to FIG. 3, a method provided herein includes transmitting a call signaling message from a first terminal to a second terminal through a telecommunication network to initiate a call, establishing a bearer channel between the first terminal and the second terminal once the call signaling message has been received by the second terminal, and determining a common mobile level. Additionally, the method includes determining two or more H.245 messages associated with set up parameters for an initial mode of operation, concatenating the two or more H.245 messages into one SRP command frame according to a predetermined size of the SRP command frame, and transmitting the SRP command frame including the two or more H.245 messages from the first terminal to the second terminal through a telecommunication network. As illustrated in FIG. 3, an AF2 message in the TCS field is concatenated with an MSD message. In other embodiments, as described more fully below, other H.245 messages are concatenated and the example illustrated in FIG. 3 is provided merely by way of example. One of ordinary skill in the art would recognize many variations, modifications, and alternatives.

Computer-readable medium are utilized herein to provide the functionality enabled by embodiments of the present invention. Generally, the computer-readable medium include instructions utilized in practicing the methods described herein.

In a particular embodiment of this method of concatenated H.245 messages, a terminal combines H.245 Request Terminal Capabilities (TCS) and Request Master Slave Determination (MSD) messages into a single H.245 PDU. It also concatenates TCS and MSD Response Messages (Acks), multiple Open Logical Channel Requests (OLC) and Multiplex Table Entry Send Request (MES) in a single H.245 PDU. Moreover, it combines OLC and MES responses into a third H.245 PDU. The process of setting up an H.324 call between two terminals that support this embodiment of the concatenation method is illustrated in FIG. 3. The result of adopting this approach reduces the number of round trips required for call setup from around ten to three. This embodiment provides that the MSDSE and CESE state machines can run in parallel, and that the multiple LCSE and MTSE state machines can run in parallel. This embodiment is merely one example of the application of the method of concatenated H.245 messages in the present invention; other concatenations of messages can be constructed. As will be evident to one of skill in the art, these may put different constraints on the signaling entity state machines within the implementation of H.245.

Optionally, the method also includes reverting to a normal operation if one of the terminals does not support concatenated H.245 messages. In this case, the calling terminal detects the lack of support since the calling terminal does not receive the H.245 response to the second of the concatenated H.245 messages. In this case, the calling terminal would revert to individual H.245 messages in the SRP command frames and retransmit the H.245 messages individually from the second message onwards. There can be many other variations, alternatives, and modifications.

Alternatively, the method can also be applied to the Numbered Simple Retransmission Protocol (numbered version of SRP which includes a sequence number in the SRP command and SRP acknowledgement frames) and other like variations. Of course, there can be other variations, modifications, and alternatives.

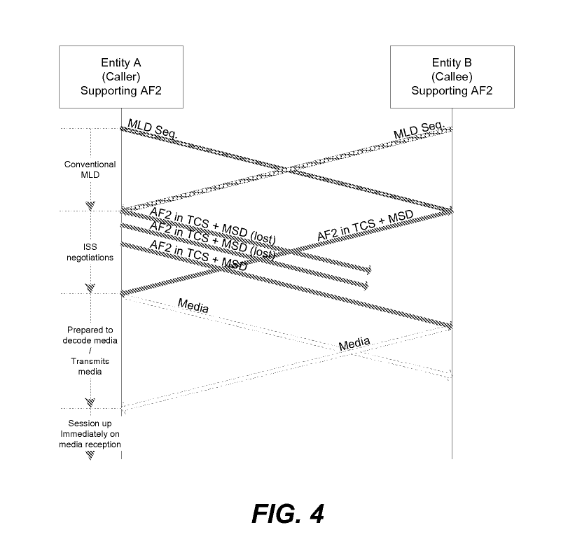

FIG. 4 is a diagram illustrating an alternative communication flow between two H.324 terminals using extensions of H.245 messages to reduce connection times for H.324 calls according to another embodiment of the present invention. As illustrated in FIG. 4, a retransmission of the H.245 messages, and underlying SRP frame or frames, can be performed. The retransmission can be performed at the network link layer, for example in a modem buffer, at the SRP layer, or at the H.245 layer. The lower layers are simple retransmissions not affecting the H.245 layer. The H.245 layer retransmission could be redundant retransmissions without regard to the standard retransmission timer or the retransmissions could be achieved by a shortening of the standard timer associated with retransmission, T401, to much less than the round trip time.

The advantages of the retransmission are most useful in errored conditions when several transmissions of a message could be lost. If a normal retransmission of around a round trip time was employed, then very large delays could be accumulated. These delays due to slow retransmission have a larger proportional impact on the setup time of the inferred method, doubling or worse the setup time from good to bad conditions. As a result, employing the retransmission technique the AnswerFast II inferred technique described herein provides better performance in error conditions and more consistent performance across a variety of network conditions.

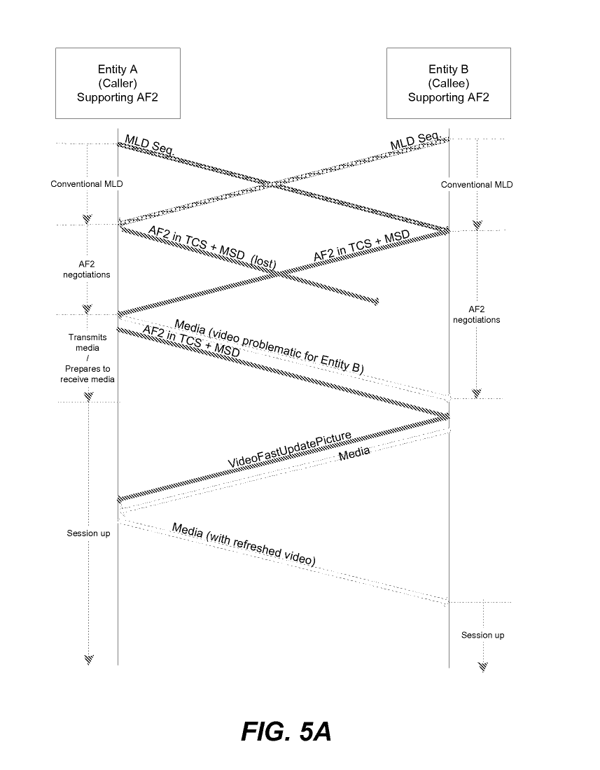

FIG. 5A is a diagram illustrating a method of recovering media after loss of a preference message according to an embodiment of the present invention. The preference/capability message, TCS, transmitted from the first terminal to the second terminal is lost and media arrives at the second terminal (Entity B) before the preferences, TCS, message. In the embodiment illustrated in FIG. 5A, if media is detected (i.e. MUX-PDUs) before the TCS/AF2 message is processed, the terminal will wait for the TCS to arrive. This sequence may occur, for example, if TCS is lost, or could also occur if a response message required for media to be able to be decoded arrives after the first media. After the TCS arrives, the AF2 negotiations are finalized and the terminal may use conventional procedures to recover an incoming media stream so that it can be decoded.

In particular applications including video, one procedure to recover media is to immediately transmit a VideoFastUpdatePicture signal allowing for clear media decoding at the arrival of the produced updated picture. This procedure is illustrated in FIG. 5A. Furthermore, the likelihood of media arriving before the capability/preference message, the TCS in this example, is reduced in some embodiments by using WNSRP with a short T401 timer, as previously mentioned with reference to FIG. 4.

According to embodiments of the present invention, the media recovery message may use a CloseLogicalChannel message with a “reopen” indication. According to other embodiments of the present invention, the media recovery message may use a new Custom message (H.245 or other) that causes a restart of media transmission to facilitate recovery.

FIG. 5B is a diagram illustrating a method of recovering media after loss of a preference message according to an embodiment of the present invention. The preference/capability message, TCS, transmitted from the first terminal to the second terminal is lost and media arrives at the second terminal (Entity B) before the preferences, TCS, message. In the embodiment illustrated in FIG. 5B, if media is detected (i.e. MUX-PDUs) before the TCS/AF2 message is processed, the terminal will wait for the TCS to arrive and, while waiting, it will buffer all arriving media. This sequence may occur, for example, if TCS is lost, or could also occur if a response message required for media to be able to be decoded arrives after the first media.

After the TCS arrives, the AF2 negotiations are finalized and the terminal may then decode the buffered media stream at faster than real time to arrive at real time decoding of the arriving media. This has the benefit of not missing any of the media at the decoder, but only displaying from the point after where the decoder can be configured correctly. The buffer may also be adaptive and need only store the media after certain key points of temporal significance, such as intra coded frames. The transmitter could also transmit more intra coded frames until such point that it has received an acknowledgment that indicates to it that the other end is fully configured. This may be an H.245 Ack or a lower level SRP Ack.

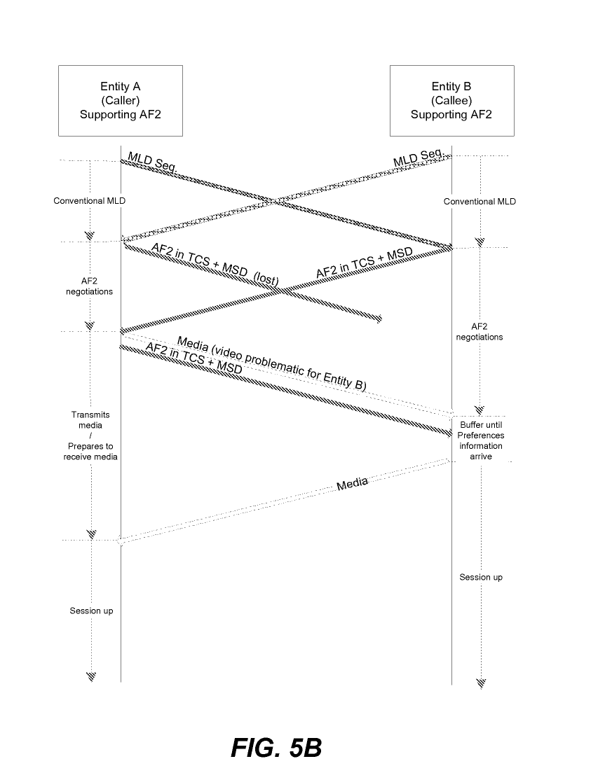

FIG. 6 is a simplified flowchart illustrating a method of reducing a call set-up time for a call between H.324-like terminals according to an embodiment of the present invention. The method (600) is considered from the perspective of one of the two terminals (referred to as a first terminal) communicating during a call and includes determining a multiplexer level (602) and sending a TCS message with an AF2 message (604). As described throughout the present specification, terminal capability information and/or preferences may be provided in a Non-Standard H.245 message or a Non-Standard field in standard messages. Alternatively, the terminal capability information and/or preferences may be provided in the GenericCapabilities field of the TCS message. In an embodiment, the terminal capability information relates to the procedures utilized to set-up the call, for example, call set-up with reduced set-up times. As illustrated in FIG. 6, multiple TCS messages with an AF2 message may be transmitted. Additionally, the process of sending one or more TCS messages with an AF2 message may be repeated, resulting in a series of groups of messages.

One or more TCS messages with an AF2 message transmitted from the second terminal are received at the first terminal (606). Utilizing the preference information in the first TCS message (604), which relates to characteristics of the first terminal, and preference information in the second TCS message (606), which relates to characteristics of the second terminal, the media channel properties are inferred (608). Additional discussion related to methods of inferring the media channel properties are provided throughout the present specification, for example, in relation to the discussion of the determination of the ICM above.

A TCS acknowledgement (TCSAck) is transmitted from the first terminal to the second terminal (610) and media may be optionally transmitted (612) after the inference of the common mode of operation. Additionally, a response to the second TCS message may be transmitted from the first terminal to the second terminal (614). A TCS acknowledgement (TCSAck) is received from the second terminal (616) and in some cases, an optional response is also received from the second terminal (618). As illustrated in process 620, embodiments of the present invention provide for the transmission of media as early as process 612 and as late as process 620. Thus, the time delay between initiating a call and sending and receiving media is reduced through the use of the methods and systems described herein.

Session characteristics may be modified (622) and additional messages may be sent and received (624) before the call is ended (626).

It should be appreciated that the specific steps illustrated in FIG. 6 provide a particular method of reducing a call set-up time for a call between H.324-like terminals according to an embodiment of the present invention. Other sequences of steps may also be performed according to alternative embodiments. For example, alternative embodiments of the present invention may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize many variations, modifications, and alternatives.

The following section defines the fast session setup (FSS) procedure as an alternative procedure for establishing an audio and video communication session in H.324. The following is a description of a FSS procedure as implemented in some embodiments of the present invention. Following this procedure, a terminal transmits the preferred operation mode as the first bits on the bearer channel. These bits are prevented from emulating existing mobile level flags, including the baseline H.324 mode, so they are ignored by existing terminals, maintaining interoperability. Embodiments of the present invention utilizing this procedure allow significant reductions in the session setup time.

According to embodiments of the present invention, methods and systems for performing a control-channel based fast session setup (FSS) procedure are provided. In a particular embodiment, the control-channel FSS is performed in an optimal manner. As described more fully below, in embodiments of the present invention, optimal fast session setup over the control-channel is achieved through use of inferred common modes (ICM).

In some embodiments, control-channel setup techniques and session acceleration techniques are impacted by the mobile level setup.

According to embodiments of the present invention, the FSS procedure includes the following steps: (1) FSS Phase; (2) Media Exchange Phase. A terminal may interrupt the FSS Phase by transmitting standard mobile level sequence flags, as described in C.6/H.324 (in Annex C of ITU-T H.324 Recommendation), and continue with a normal set-up procedure as described in C.6.2/H.324.

The FSS frames are octet aligned and have the structure shown in Table 3.

TABLE 3
Structure of a Fast Session Setup frame

Frame Information (FI) (1 octet)
Reserved (Always 0x00) (1 octet)
Payload Length (PL) (1 octet)
Payload
(0 or more octets up to 150 octets)
CRC (2 octets)

The FI bit allocation is shown in Table 4. Bit 8 is reserved and is set to 1. Bit 7 represents the Last Segment (LS) flag, and the three following bits represent the Segment Sequence Number (SSN). The three least significant bits are reserved and are set to 0. The use of LS and SSN are specified in 7.1.

TABLE 4
Structure of the Fast Session Setup Frame Information field

| 8 | 7 | 6 | 5 | 4 | 3 | 2 | 1 | |
|---|---|---|---|---|---|---|---|---|
| 1 | LS | SSN3 | SSN2 | SSN1 | 0 | 0 | 0 | Octet 1 |

The Payload Length (PL) field indicates the payload size in octets before the application of the Frame Emulation Avoidance (FEA) procedure. Generally, the FSS frame payload (FSS-PDU) will not exceed 150 octets. According to some embodiments, the receiver supports overall FSS-SDU (FSS message) payload length of up to 1050 octets excluding octets inserted during FEA.

The Payload corresponds to an FSS-SDU or an FSS-SDU segment. FSS-SDU corresponds to an H.245 genericRequest message (using GenericMessage), and is encoded according to Packed Encoding Rules (PER) as defined in ITU-T Rec. X.691. The CRC (cyclic redundancy check) field is 16 bits and is determined by applying the CRC described in 8.1.1.6.1/V.42 to the entire frame, excluding the FSS Synchronization Flags and the CRC field, and before FEA. On detecting a CRC error or undefined FI or undefined Reserved bits, the corresponding FSS frame will be discarded.

The FSS Synchronization Flag is defined as shown in Table 5:

TABLE 5
Structure of the FSS Synchronization Flag

| | |
|---|---|
| 0xA3 | 1010 0011 |
| 0x35 | 0011 0101 |

According to some embodiments of the present invention, one FSS Synchronization Flag is inserted immediately before and after each FSS Frame. In a particular embodiment, only one FSS Synchronization Flag is provided between two consecutive FSS Frames.

Embodiments of the present invention provide for a Payload Segmentation and Reassembly (PSR) procedure. the PSR procedure is identical to the Command and Control Segmentation and Reassembly Layer (CCSRL) procedure as described in C.8.1/H.324 with the following modifications:
FSS LS flag is used in place of CCSRL LS. LS is set to 1 on the FSS-PDU containing the last segment of an FSS-SDU. Otherwise, LS is set to 0.
The SSN is set to 0 for the first segment and monotonically incremented for each segment. The maximum value of SSN is 6. The value 7 is reserved.

Before transmitting an FSS frame onto the bearer, an FEA procedure is generally performed against synchronization flags for all mobile levels of H.324. FI, Segment Sequence Number, Payload Length, Payload and CRC are included in the FEA procedure. All octets with values 0xA3, 0x35, 0xE1, 0x4D, 0x1E, 0xB2, 0x19, 0xB1, 0x7E and 0xC5 shall have an octet with value 0xC5 inserted immediately preceding them.

In embodiments of the present invention, a terminal inserts stuffing flags of its mobile level, as described in C.6.1/H.324, between FSS Frames encapsulated with FSS Synchronization Flags. In a particular embodiment, no more than 10 flags are inserted. In an other particular embodiment, for mobile level 0, no more than 20 flags are inserted. Of course, the number of flags inserted will depend on the particular applications. One of ordinary skill in the art would recognize many variations, modifications, and alternatives.

Once the bearer is established, a terminal supporting FSS will send its FSS Request. In an embodiment, the FSS Request is sent immediately after bearer establishment. The Request transmissions should be repeated until an FSS Request is detected, or one of the conditions in the FSS fallback procedure is fulfilled. For the latter case, the procedure in the FSS fallback procedure will be followed.

When an FSS Request is detected and decoded successfully, the terminal accepts it by beginning the transmission and processing of media data as determined by the ICM at NMLO using the agreed mobile level. For the master-slave determination, when the terminalType fields in the FSS Request of the two terminals are identical the caller shall be the master. When the terminalType fields differ, the terminal which has higher terminalType value shall be the master.

In some embodiments, unexpected FSS-SDUs shall be discarded.

Logical Channels

A terminal indicates its requested logical channels by listing H.245 OpenLogicalChannel (OLC) requests according to an order of preference in mediaProfile. The requests shall be processed in the same order.

Logical channel numbers (LCNs) are assigned by the message originator. OLC requests with the same LCN indicate alternative media capabilities for the logical channel. For bidirectional logical channels, the reverse LCN shall be the same as the forward LCN. If a reverse LCN is already assigned, the next available LCN shall be assigned. The highest LCN shall be 14, and any OLC requests that lead to LCN exceeding 14 shall be ignored.

If ICM contains an H.223 adaptation layer type not supported by a terminal, the terminal shall fallback as described in the FSS Fallback Procedure.

Multiplex Table Entries

The logical channel number shall be mapped to H.223 multiplex entry index. For example, if logical channel 1 is opened, multiplex entry index 1 will be associated to this logical channel as “{LCN1, RC UCF}”. For a reverse logical channel, the logical channel number shall be mapped to multiplex entry index at the H.223 demultiplexer.

FSS Fallback Procedure

A fallback procedure shall be used by an FSS terminal to switch to normal operation mode.

During fallback, a terminal shall stop transmitting FSS frames, ignore the FSS outcome and follow normal start up procedures as defined in H.324 Annex C.

According to some embodiments, the following conditions shall initiate fallback:
More than 20 valid consecutive mobile level stuffing flags are detected, as described in C.6/H.324;
A normal start up procedure with a normal H.245 TerminalCapabilitySet message as the first non-empty H.223 MUX-PDU at an agreed initial mobile level is detected, regardless of whether the terminal has completed the FSS procedure.
A terminal does not detect a valid FSS request, or does not accept the ICM, within a multiple of the network round trip delay (RTD) period. Typically, 3 RTDs is adopted.

Terminal Procedures

The steps for provision of communication are as listed in clause C.5/H.324 with the following modifications:

Phase D: FSS phase, as specified in this annex, is inserted before the level set-up procedure. If FSS is completed successfully, H.245 message exchange is skipped and opened logical channels operate immediately. If FSS fallback occurs, the connection continues from the level set-up procedure.

Any of the above techniques can be combined, further separated, and/or added to without departing from the scope of the present invention. One of ordinary skill in the art would recognize many variations, modifications, and alternatives.

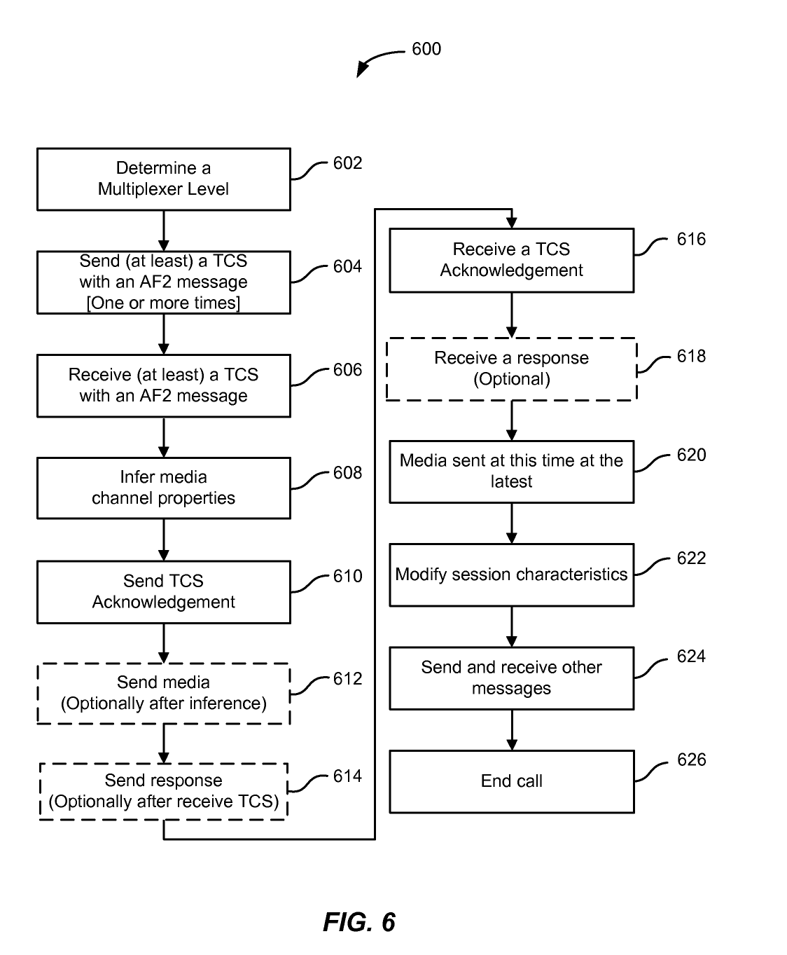

FIG. 7 illustrates Object Identifier Assignments for an FSS procedure according to an embodiment of the present invention.

Embodiment in the Context of a H.324/H.323 Gateway:

A further embodiment uses a gateway to an H.323 terminal using “FastConnect.” These embodiments offer a significant reduction in call set-up time. These embodiments eliminate all round trip exchange for H.245 messages.

Embodiment in the Context of a H.324/SIP Gateway:

The embodiment in this context is similar to that of the H.324/H.323 gateway with the exception that the gateway converts the information (Type II and ICM) to SIP signaling messages.

Additionally, any terminal may support Type III and another terminal may support Type I/II, or possible variants of the same type. Both terminals should be able to operate at their common support type (i.e. in this case Type II) as if the calling terminal would not receive the Type III response in the call signaling phase. The general mode is that terminals fall back to the highest common mode and within that mode to the highest supported version. Of course, there may be variations, alternatives, and modifications.

Embodiments of the present invention provide methods and systems to optimize H.324 SRP to support faster call setup, call tear-down, and other session messaging (H.245 Messaging) in environments where network latency is significant. One of the features of H.324/H.245 is the use of SRP, which provides acknowledgement for all delivered PDUs. This is useful to ensure that all command and control messages have been received at the far end terminal, but provides a limit to the throughput of messages on networks with moderate to high latency (>40 ms round trip time).

In conventional systems, SRP only allows for one message to be outstanding at any time to ensure guaranteed delivery and correct message sequencing. This latency can be mitigated to some extent by minimizing the number of messages exchanged during call setup through the use of concatenation, for example transmitting a message containing multiple Multiplex Table Entries, or combining Terminal Capability Set and Master Slave determination messages, however it does still adversely impact the call set-up time.

In addition, timeouts are such within H.324/H.245 that if a critical packet (or its acknowledgement) is lost during call set-up (e.g., perhaps due to data loss) the call may fail and abort if timer values within stack implementations are not tuned appropriately. Embodiments of the present invention provide methods and systems that remain standards compliant, but utilize SRP in such a way to allow messages to be sent while an SRP ACK is outstanding.

In many cases, the H.324/H.245 procedures are artificially held back due to the behavior of H.245/SRP. For example, essentially independent procedures, such as the opening of different logical channels, are unnecessarily coupled by the requirement that only one H.245 SDU may be outstanding at any time. By removing this limitation for independent procedures it is estimated that the time to execute H.245 procedures could be reduced by between 50-100%.

Embodiments of the present invention preserve some SDUs in strict order, for example with procedures such as a TCS, then awaiting a TCSAck, followed by OLC procedures, or within a single instance of an Open Logical Channel procedure. However independent OLC requests do not need to be coupled as they are in the current standard.

In order to allow new SDUs to be transmitted while SRP ACKs are outstanding, a means of identifying SRPs and associating them with the relevant message is provided. One approach is to use Numbered SRPs. An alternative to this first approach is based on a Selective ACK, or a sliding window approach, as described below.

In order to minimize implementation complexity and maintain maximum consistency, some embodiments utilize a sliding window approach. This will allow the H.324/H.245 implementation to send a maximum predetermined number (n) of SRP packets without corresponding ACKs being received. The H.245 implementation itself maintains locking to ensure that only one SDU ACK is outstanding from each state machine instance (typically per H.245 procedure), otherwise message sequences within each state machine cannot be guaranteed.

In order to enable this behavior, embodiments provide that the H.324 entity is able to signal to the far end that it is capable of handling these approaches. One possibility is to include information related to this capability with Terminal Capability Set, as is the case with NSRP. It is likely that an alternative header field would be required to specify the remote handling of this case. In the case where the fast session set-up techniques described above are used, this will have no impact on call set-up time, however it will improve speed and reliability for subsequent H.245 control operations.

The previous description of the preferred embodiment is provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein. For example, the functionality above may be combined or further separated, depending upon the embodiment. Certain features may also be added or removed. Additionally, the particular order of the features recited is not specifically required in certain embodiments, although may be important in others. The sequence of processes can be carried out in computer code and/or hardware depending upon the embodiment. Of course, one or ordinary skill in the art would recognize many other variations, modifications, and alternatives.

Additionally, it is also understood that the examples and embodiments described herein are for illustrative purposes only and that various modifications or changes in light thereof will be suggested to persons skilled in the art and are to be included within the spirit and purview of this application and scope of the appended claims.

1. A method of reducing a call set-up time between a pair of H.324-like terminals coupled to one or more telecommunication networks, the method comprising:
providing a first capability identifier in at least one of a non-standard or generic field of a first TCS message;
transmitting the first capability identifier from the first H.324-like terminal to the second H.324-like terminal;
receiving, at the first H.324-like terminal, a second capability identifier in at least one of a non-standard or generic field of a second TCS message, wherein the second TCS message is transmitted from the second H.324-like terminal;
determining, at the first H.324-like terminal, a mode of operation by utilizing an inference algorithm, wherein determining is based upon at least the first capability identifier and the second capability identifier; and
transmitting media from the first H.324-like terminal to the second H.324-like terminal, wherein transmitting media is performed in accordance with the determined mode of operation.

2.-3. (canceled)

4. The method of claim 1 wherein the first capability identifier is provided in a genericInformation.messageIdentifier field of the first TCS message.

5. The method of claim 1 wherein the mode of operation comprises a use of one or more logical channels.

6. The method of claim 5 wherein the one or more logical channels comprise an audio logical channel.

7. The method of claim 5 wherein the one or more logical channels comprise a video logical channel.

8. The method of claim 1 wherein the mode of operation comprises a use of one or more logical channels operating on one or more multiplexer table entries and wherein the one or more multiplexer table entries are determined based, in part, on the first capability identifier.

9. (canceled)

10. The method of claim 1 wherein determining further comprises selecting codecs implicitly to provide logical channels containing media without completion of H.245 logical channel procedures.

11. The method of claim 1 wherein the determined mode of operation is confirmed by a response message received at the first H.324-like terminal after transmission from the second H.324-like terminal.

12. The method of claim 11 wherein the response message is provided as one or more media streams.

13. The method of claim 11 wherein the response message comprises an H.245 OpenLogicalChannel message.

14.-17. (canceled)

18. The method of claim 1 wherein the first capability identifier includes a multiplexer table entry number.

19. The method of claim 1 wherein transmitting media is performed prior to receiving any additional H.245 messages.

20. The method of claim 1 wherein transmitting media is performed at a time substantially equal to one round trip time after the completion of a call signaling process.

21. The method of claim 1 wherein transmitting media is performed prior to receiving a TCS acknowledgement message from the second H.324-like terminal.

22.-27. (canceled)

28. A method of reducing a call set-up time for a call between a first terminal and a second terminal, the call using one or more telecommunication networks, the method comprising:
providing a first capability identifier in a GenericCapabilities field of a first TCS message;
transmitting the first TCS message from the second terminal to the first terminal;
receiving a first media stream at the second terminal prior to receiving a second TCS message from the first terminal, wherein the second TCS message includes a second capability identifier in a GenericCapabilities field of the second TCS message;
thereafter receiving the second TCS message at the second terminal;
determining a mode of operation for the call based upon the first capability identifier and the second capability identifier;
performing a media recovery operation;
receiving a second media stream at the second terminal; and
decoding the second media stream, wherein decoding the second media stream is performed in accordance with the determined mode of operation.

29.-30. (canceled)

31. The method of claim 28 wherein the first media stream is buffered at the second terminal and performing a media recover operation comprises decoding the first media stream buffered at the second terminal.

32.-33. (canceled)

34. The method of claim 28 wherein the first media stream is characterized by an intra frame transmission frequency greater than an intra frame transmission frequency characteristic of the second media stream.

35. (canceled)

36. The method of claim 28 further comprising transmitting media from the second terminal to the first terminal after performing the media recovery operation and prior to receiving any additional H.245 messages.

37.-38. (canceled)

39. The method of claim 28 wherein the first capability identifier is provided in a genericInformation.messageIdentifier field of the first TCS message.

40. The method of claim 28 wherein the mode of operation comprises a use of one or more logical channels operating on one or more multiplexer table entries.

41. The method of claim 40 wherein the one or more multiplexer table entries are determined based, in part, on the first capability identifier.

42. The method of claim 28 wherein determining a mode of operation further comprises selecting codecs implicitly to provide logical channels containing media, wherein selecting codecs is performed without completion of H.245 logical channel procedures.

43. The method of claim 28 wherein the first capability identifier includes a multiplexer table entry number.

44.-45. (canceled)

46. The method of claim 28 further comprising transmitting a media recovery signal from the second terminal to the first terminal, wherein the media recovery signal comprises at least one of a VideoFastUpdatePicture signal, a CloseLogicalChannel signal, or a custom signal.

47. (canceled)

48. The method of claim 28 wherein the first terminal comprises a first 3G-324M terminal and the second terminal comprises a second 3G-324M terminal.

49.-89. (canceled)
